(19) United States
(12) Patent Application Publication
(10) Pub. No.: US 2005/0192862 A1
(43) Pub. Date: Sep. 1, 2005

(54) Methods, systems, and articles of manufacture for providing incentives for a financial account

(75) Inventor: Manaw Modi, Richmond, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Capital One Financial Corporation

(21) Appl. No.: 10/787,208

(22) Filed: Feb. 27, 2004

(51) Int. Cl. G06F 17/60

(52) U.S. Cl. 705/14; 705/35

(57) ABSTRACT

Methods, systems, and articles of manufacture for providing incentives for a first financial account held by a user and associated with a first financial account provider. The user also holds a second financial account associated with a second financial account provider and performs transactions using at least one of the first and second financial accounts. In one embodiment, a system and method is provided that monitors the transactions performed by the user using the first and second financial accounts over a predetermined transaction monitoring period. Further, the system and method may determine whether the monitored transactions meet at least one predetermined condition and, based on the predetermined condition, applies an incentive to the first financial account. In another embodiment, a system and method is provided that may monitor the transactions performed using the first and second financial accounts and may determine whether the monitored transactions include at least one transaction associated with the second financial account. Based on the determination, the method and system may transfer the at least one second financial account transaction to the first financial account such that the first financial account provider may send a payment to the second financial account provider for the at least one second financial account transaction and apply a total purchase amount for the at least one second financial account transactions to a balance of the first financial account.

### BACKGROUND OF THE INVENTION

I. Field of the Invention

This invention relates to financial account products and, more particularly, to systems, methods, and articles of manufacture for providing incentives for a financial account based on transactions associated with other financial accounts.

II. Background and Material Information

Credit card accounts have become such a common tool of commerce that consumers no longer limit their use to simply purchasing goods. Today, consumers leverage credit card accounts to purchase services, pay down outstanding debts, and even finance education. Armed with this knowledge, financial account providers, such as credit card issuers, merchants, etc., employ various marketing schemes to increase usage of their products. For instance, a credit card issuer may offer incentives to consumers for using their product over a competitors when purchasing goods and/or services. These incentives may include discounts on purchased items, adjustments to account parameters (e.g., interest rate), and rewards, such as bonus airline miles, free gifts, reward point schemes, and reduced account fees.

In order to attract or retain customers, credit card issuers may implement incentive programs that allow a cardholder to accumulate reward points based on purchases made with the issuer's credit card. A cardholder may use the accumulated points to receive goods and/or services provided by the credit card issuer and/or third party vendors. For example, credit card issuers may offer credit card products associated with refueling stations for vehicles, such as a franchised gas station. When a cardholder makes purchases at the franchised gas station, the credit card issuer may credit the cardholder's account with a certain number of points. These points may reflect a proportional amount of the cardholder's purchase (e.g., for fuel) from the franchised gas station. Other types of vendors have “teamed up” with credit card issuers to provide similar incentives, whereby a cardholder may receive goods and/or services proportional to a certain number of points credited to their account. For example, some financial accounts allow consumers to earn “frequent flier miles” with an airline company by making purchases with the financial account.

Although such incentive programs are attractive to consumers, they are also popular among card issuers. In fact, it is common for a consumer to hold several credit cards from different credit card issuers implementing such programs. Accordingly, such conventional incentive practices rely on rewards that are attractive to a consumer in hopes that the consumer will chose one card over another when purchasing goods or services.

### SUMMARY OF THE INVENTION

Accordingly, there is a need for an improved method, system, and article of manufacture for providing a financial account associated with incentives that motivate a consumer to use the account over another third party financial account when purchasing goods and/or services.

Methods, systems, and articles of manufacture consistent with the principles of the present invention provide incentives for a first financial account held by a user and associated with a first financial account provider. The user also holds a second financial account associated with a second financial account provider and performs transactions using at least one of the first and second financial accounts. In one embodiment, a method is provided that monitors the transactions performed by the user using the first and second financial accounts over a predetermined transaction monitoring period. Further, the method determines whether the monitored transactions meet at least one predetermined condition and, based on the predetermined condition, applies an incentive to the first financial account.

In another embodiment, a method is disclosed for providing incentives for a first financial account held by a user and associated with a first financial account provider. The user also holds a second financial account associated with a second financial account provider. The method includes monitoring transactions performed using the first and second financial accounts over a predetermined transaction monitoring period and determining whether the monitored transactions include at least one transaction associated with the second financial account. Further, the method includes transferring the at least one second financial account transaction to the first financial account such that the first financial account provider sends a payment to the second financial account provider for the at least one second financial account transaction and applies a total purchase amount for the at least one second financial account transactions to a balance of the first financial account.

In yet another embodiment, a system is disclosed for providing incentives for a first financial account. The system includes a first financial account provider managing the first financial account, a second financial account provider managing a second financial account, and a user associated with the first and second financial accounts. Additionally, the first financial account provider is configured to monitor purchase transactions performed by the user over a transaction time period, determine whether the purchase transactions meet at least one predetermined condition, and apply an incentive to the first financial account based on the predetermined condition.

It is to be understood that both the foregoing general description and the following detailed description are exemplary and explanatory only and are not restrictive of the invention, as described. Further features and/or variations may be provided in addition to those set forth herein. For example, the present invention may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, illustrate various embodiments and aspects of the present invention and, together with the description, explain the principles of the invention. In the drawings:

FIG. 1 illustrates an exemplary system environment in which certain features and principles related to the present invention may be implemented;

FIG. 2 is a flowchart of an exemplary incentive transaction process, consistent with certain embodiments of the present invention;

FIG. 3 is a flowchart of an exemplary transaction priority process, consistent with certain embodiments of the present invention; and

FIG. 4 is a flowchart of an exemplary incentive process, consistent with certain embodiments of the present invention.

### DETAILED DESCRIPTION

Reference will now be made in detail to the invention, examples of which are illustrated in the accompanying drawings. Wherever possible, the same reference numbers will be used throughout the drawings to refer to the same or like parts.

Generally, the present invention is directed to methods, systems, and articles of manufacture for providing incentives for a first financial account managed by a first financial account provider and held by a user. The user may also hold one or more secondary financial accounts with respective second financial account providers and may perform purchase transactions using the first and secondary financial accounts. The first financial account provider is configured to monitor and collect transaction information associated with the accounts over a predetermined transaction time period. The first financial account provider performs one or more processes that filter the collected transaction information to identify a predefined number of transactions that have certain attributes, such as the top five transactions with the highest transaction purchase amounts. Using the filtered transaction information, the first financial account provider determines and applies selected incentives to the first financial account based on conditions, such as whether all, a portion, or none, of the transactions were performed with the first financial account.

Additionally, the first financial account provider is configured to transfer any transactions associated with the secondary financial accounts to the first financial account. This may include adding a total transaction amount for the transferred secondary financial accounts to the current balance of the first financial account. The first financial account provider may also be configured to provide payment to the second financial account providers managing the secondary accounts associated with the transfer.

The above-noted features and other aspects and principles of the present invention may be implemented in various environments. Such environments and related applications may be specially constructed for performing the various processes and operations of the invention or they may include a general purpose computer or computing platform selectively activated or reconfigured by program code to provide the necessary functionality. The processes disclosed herein are not inherently related to any particular computer or other apparatus, and may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

The present invention also relates to computer readable media that include program instruction or program code for performing various computer-implemented operations based on the methods and processes of the invention. The program instructions may be those specially designed and constructed for the purposes of the invention, or they may be of the kind well-known and available to those having skill in the computer software arts. Examples of program instructions include for example machine code, such as produced by a compiler, and files containing a high level code that can be executed by the computer using an interpreter.

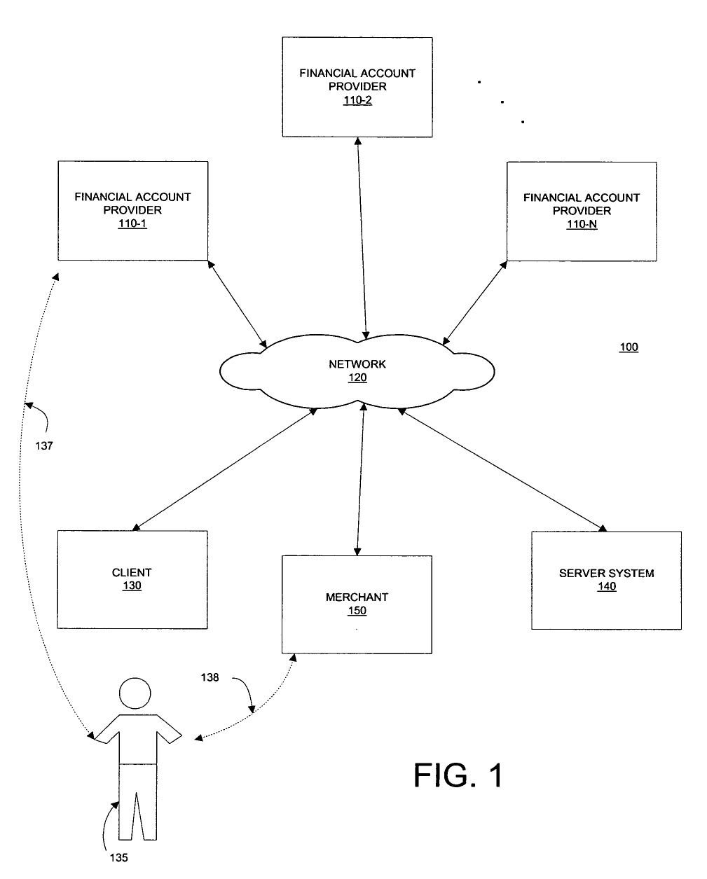

FIG. 1 illustrates an exemplary system environment 100 in which the features and principles of the invention may be implemented. As illustrated in FIG. 1, the system environment 100 includes a plurality of financial account providers 110-1 to 110-N, a network 120, a client 130, and a server system 140 and a merchant 150.

Financial account providers 110-1 to 110-N may represent entities that configure, offer, and manage financial accounts, such as credit cards, to one or more customers, such as user 135. While systems, methods, and articles of manufacture consistent with embodiments of the present invention are described herein with respect to credit cards, the present invention may be used for any type of financial account in which payments are made to a financial account provider. Each provider 1 10-1 to 110-N may include processing components that enable and process communications between remote entities through network 120 or any other suitable communications infrastructure. For instance, financial account provider 110-1 may include a computer system (not shown) that performs one or more processes consistent with embodiments of the present invention. The computer system may include one or more processing devices, memory devices, interface devices, data, and executable software that allows financial account provider 110-1 to provide a financial account to a customer having incentive program parameters consistent with embodiments of the present invention. It should be understood that financial account providers 110-2 to 110-N may also include similar computer system devices and capabilities.

Network 120 may be any type of network configuration that facilitates communications between components, such as financial account providers 110-1 to 110-N and client 130. Network 120 may be a local area network (LAN), a wide area network (WAN), a dedicated intranet, the Internet, and/or a wireless network. Further, any suitable combination of wired and/or wireless components and systems may be incorporated into network 120. Moreover, any part of network 120 may implemented through traditional infrastructures or channels of trade, to permit operations associated with financial accounts that are performed manually or in-person by the various entities illustrated in FIG. 1.

Client 130 is a computer system operated by a user 135 that performs one or more client based processes consistent with embodiments of the present invention. Client 130 may include one or more processing devices, memory devices, interface devices, and software (all not shown) that allow user 135 to request, receive, and send data to and from network 120. Further, client 130 is configured with software and/or hardware that enables communications with remote entities through other dedicated communication channels. User 137 may leverage browser software executed by client 130 to request and view content rendered on a web page provided by a web server. Moreover, user 135 may exchange information with a financial account provider, such as financial account provider 110-1, through communication channel 137, which may include standard U.S. postal service channels or equivalent types of communication mediums. For example, user 135 may receive financial account information from financial account provider 110-1 through non-government operated mail services (e.g., privately operated services using communication channel 137).

Server system 140 is a computer system that performs certain transaction collection processes consistent with embodiments of the present invention. Server system 140 may include one or more processing devices, memory devices, interface devices, and software (all not shown) that process information associated with financial account providers 110-1 to 110-N and/or client 130. In one embodiment, server system 130 includes a database that stores transaction information associated with one or more financial accounts held by user 135 and managed by respective one or more financial account providers 110-1 to 110-N.

Merchant 150 is one or more entities associated with vendors of goods and/or services that are purchased by consumers, such as user 138. For example, merchant 150 may represent a vendor that offers goods that are purchased by user 135 using one or more of the financial accounts held by the user and managed by financial account providers 110-1 to 110-N. User 135 may purchase goods and/or services from merchant 150 over network 120 (i.e., telephonically, “on-line” via the Internet) or over normal channels of trade 138 (i.e., Point of Sale (POS) purchase). Merchant 150 may include computer system components that allow it to exchange information with remote entities through network 120.

Although FIG. 1 describes a certain number of entities within environment 100, any number of entities may be implemented. For example, more than one client 130 may be connected to network 120 that are each associated with a separate user. Also, many different merchants 150 may serve many different users through network 120 or through standard channels of trade, such as face-to-face purchase transactions.

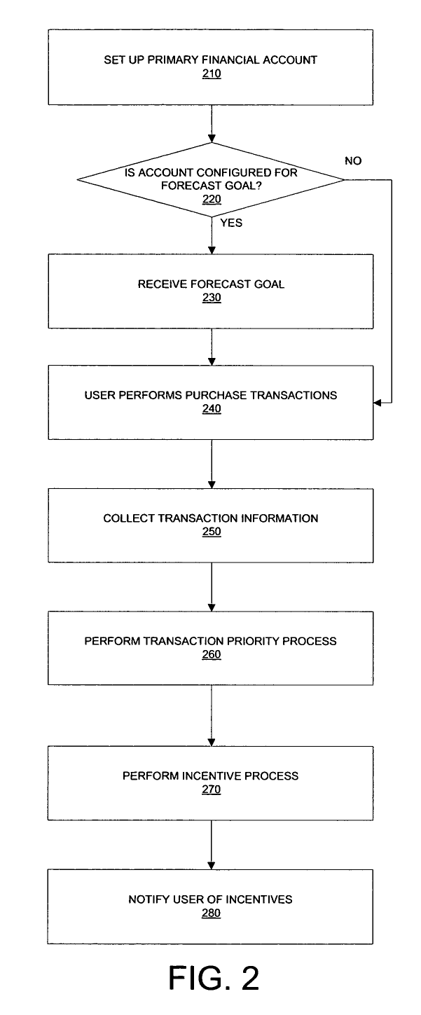

Systems and methods consistent with embodiments of the present invention enable a financial account provider to provide incentives for motivating user 135 to use one financial account over another when purchasing goods and/or services. FIG. 2 shows a flowchart of an incentive transaction process that may be performed by a financial account provider, such as financial account provider 110-1. To better illustrate the embodiments of the present invention, the incentive transaction process is described in connection with user 135 holding a first financial account (i.e., primary financial account) managed by financial account provider 110-1 and a second financial account (i.e., secondary financial account) managed by financial account provider 110-2. It should be understood, however, that user 135 may hold financial accounts managed by other financial account providers (e.g., financial account provider 110-N) and that the incentive transaction process may be performed by any one of the financial account providers 110-1 to 110-N. In alternative embodiments, the incentive transaction process may be performed by an entity that does not offer or manage financial accounts for user 135, but instead performs incentive transaction processes for an account provider that manages such accounts.

Initially, financial account provider 110-1 may configure a primary financial account for user 135 (Step 210). Configuring the account may include setting up a new financial account for user 135 or reconfiguring an existing financial account managed by financial account provider 110-1.

Financial account provider 110-1 configures the primary financial account by offering and providing predetermined parameters for the account based on, for example, the profile of user 135, such as credit worthiness, past financial performances, employment history, etc. The parameters may include interest rate, credit limit, penalty fee conditions, financial account usage conditions, and any other terms that may be associated with the type of financial account provided to user 135.

In addition to financial account parameters, financial account provider 110-1 may also configure parameters associated with an incentive program consistent with embodiments of the present invention. The incentive program parameters may include conditions and incentives that user 135 may realize through the primary financial account based on usage terms configured in the incentive program. For example, financial account provider 110-1 may configure an incentive program that allows user 135 to provide financial account provider 110-1 with forecasted usage data associated with the primary financial account. For instance, under one incentive parameter, user 135 may provide financial account provider 110-1 with a forecast goal of predicted transaction amounts for a future period of time (e.g., the next 30 days, six months, etc.). The future transaction information may include predicted monetary amounts and numbers of transactions user 135 intends to perform during the future period of time. Based on the terms of the above exemplary incentive program parameters, the user may be eligible to receive selected incentives depending upon whether the user meets the forecast goal provided to financial account provider 110-1. Financial account provider 110-1 may apply one or more incentive rules based on the parameters configured for the incentive program. These rules are applied when user transactions are processed for determining the type of incentives to apply to the primary financial account. Financial account provider 110-1 stores the predicted financial transaction information in a memory location associated with the financial account for subsequent processing.

Financial account provider 110-1 may configure other types of incentive program parameters. In one embodiment, financial account provider 110-1 may configure an incentive program that allows provider 110-1 to transfer transactions associated with user 135 and other financial accounts managed by third party financial account providers, such as provider 110-2. Accordingly, financial account provider 110-1 may request and receive authorization from user 135 to obtain information regarding any future third party transactions associated with one or more third party financial accounts managed by one or more secondary financial account providers, such as financial account provider 110-2. User 135 may provide financial account provider 110-1 with an acceptance and authorization for provider 110-1 to monitor and process a selected number of future transactions associated with a selected number of secondary financial accounts.

Based on the user's authorization, financial account provider 110-1 configures a monitoring process for monitoring and collecting transaction information associated with a user selected number of secondary financial accounts. In certain embodiments, user 135 may select a certain number of transactions that financial account provider 110-1 monitors for certain secondary financial accounts. Thus, if user 135 holds secondary financial accounts with financial account providers 110-2 and 110-N, financial account provider 110-1 allows user 135 to select which secondary financial accounts are associated with the incentive program, as well as the number of transactions that are associated with the selected secondary financial account (e.g., first 5 transactions) Alternatively, or additionally, user 135 may select that only secondary financial account transactions of certain amounts are to be configured with the incentive program. Financial account provider 110-1 configures a data structure (e.g., table, array, etc.) associated with each selected secondary account to enable provider 110-1 to monitor and collect the transaction information for subsequent processing.

Once the incentive program parameters are configured, financial account provider 110-1 may activate the primary financial account. Financial account provider 110-1 may then determine whether the primary financial account is configured with a future transaction goal parameter (Step 220) and if so (Step 220; YES), financial account provider 110-1 may request and receive a forecast goal for a predetermined future period of time (Step 230). If the primary financial account is not configured with a forecast goal parameter (Step 220; NO), the incentive transaction process may proceed to Step 240.

Subsequently, user 135 may perform purchase transactions using at least one of the primary financial account and any secondary financial accounts held by user 135 (Step 240). For exemplary purposes only and to illustrate embodiments of the incentive transaction process, user 135 may purchase goods and/or services using the primary financial account and the secondary financial account managed by financial account provider 110-2 in accordance with Table 1. It is understood, however, that user 135 may perform any number of transactions using any combinations of financial accounts over any period of time and that the transactions listed in Table 1 are not intended to be limiting.

TABLE 1
Exemplary Transactions

| Transaction | Financial | Transaction | Transaction |
|---|---|---|---|
| number | Account | amount | date |
| T1 | Primary Financial | 500.00 | Mar. 10, 2004 |
| | Account | | |
| T2 | Secondary Financial | 1500.00 | Mar. 15, 2004 |
| | Account | | |
| T3 | Secondary Financial | 450.00 | Mar. 17, 2004 |
| | Account | | |
| T4 | Secondary Financial | 300.00 | Mar. 22, 2004 |
| | Account | | |
| T5 | Primary Financial | 250.00 | Mar. 29, 2004 |
| | Account | | |
| T6 | Secondary Financial | 28.00 | Mar. 29, 2004 |
| | Account | | |
| T7 | Primary Financial | 100.00 | Mar. 30, 2004 |
| | Account | | |

Financial account provider 110-1 may monitor and collect information associated with user transactions using the primary and/or secondary financial accounts (Step 250). In one embodiment, financial account provider 110-1 receives the transaction information associated with the primary financial account from any merchant 150 associated with the transaction. Because secondary financial account transactions are not affiliated with financial account provider 110-1, these transactions may be collected using different methods and techniques. For example, financial account provider 110-1 may receive secondary financial account transaction information directly from user 135 through communication channel 137. In this instance, user 135 may forward a copy of a financial account statement issued by financial account provider 110-2 for previous transactions associated with the secondary financial account. Alternatively, user 135 may forward the secondary financial account information electronically via client 130 and network 120. This may be performed using electronic mail services or other forms of electronic communication technologies.

In another embodiment, financial account provider 110-1 may retrieve the secondary financial account information directly from financial account provider 110-2, via network 120 or other types of communication channels, such as a communication channel similar to channel 137. For example, financial account provider 110-1 may request and receive the secondary finance account transaction information from financial account provider 110-2 via electronic mail services or other types of network communication protocols and technologies. Alternatively, financial account provider 110-1 may request and receive the secondary financial account transaction information from server system 140, which is configured to log transaction information associated with financial accounts held by user 135. In this instance, financial account provider 110-1 may issue a request over network 120 to retrieve stored transaction information associated with secondary financial account transactions for user 135. Server system 140 may process the request by searching a database for the requested transactions and returning the requested information to financial account provider 110-1 via network 120.

It should be noted that the above methodologies for collecting the secondary financial account transaction information is exemplary and embodiments of the present invention are not limited to the above examples. Indeed, financial account provider 110-1 may be configured to collect this information using other types of technologies and processes for incentive program processing.

Following the exemplary transactions listed in Table 1, financial account provider 110-1 collects the transaction information associated with user 135 for a previous period of time and stores this data in a memory device (Step 250). Provider 110-1 may then perform a transaction priority process consistent with certain embodiments of the present invention (Step 260).

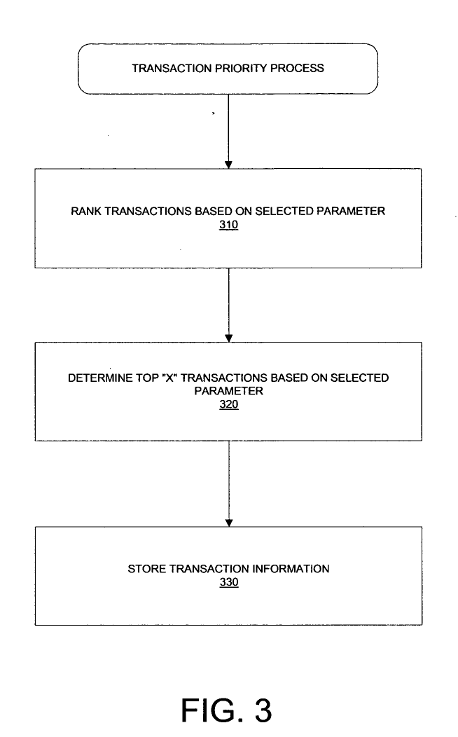

FIG. 3 shows a flowchart of an exemplary transaction priority process for implementing step 260 of FIG. 2, consistent with certain embodiments of the present invention. As shown, financial account provider 110-1 may analyze the collected primary and secondary financial account transaction information and rank the transactions based on a selected transaction parameter (Step 310). In one aspect, financial account provider 110-1 may rank the transactions based on the purchase amount of each transaction. Referring to the exemplary transactions listed in Table 1, financial account provider 110-1 may rank and store the transactions based on the transaction amount indicated in the second column of the table. Financial account provider 110-1 may then store the ranked transaction information in a memory device for subsequent processing. Table 2 shows a listing of the transaction information that is stored in the data structure following the exemplary ranking process performed in Step 310.

TABLE 2
Ranked Transactions

| | Transaction | Financial | Transaction | Transaction |
|---|---|---|---|---|
| Rank | number | Account | amount | date |
| 1 | T2 | Secondary | 1500.00 | Mar. 15, 2004 |
| | | Financial Account | | |
| 2 | T1 | Primary Financial | 500.00 | Mar. 10, 2004 |
| | | Account | | |
| 3 | T3 | Secondary | 450.00 | Mar. 17, 2004 |
| | | Financial Account | | |
| 4 | T4 | Secondary | 300.00 | Mar. 22, 2004 |
| | | Financial Account | | |
| 5 | T5 | Primary Financial | 250.00 | Mar. 29, 2004 |
| | | Account | | |
| 6 | T7 | Primary Financial | 100.00 | Mar. 30, 2004 |
| | | Account | | |
| 7 | T6 | Secondary | 28.00 | Mar. 29, 2004 |
| | | Financial Account | | |

Once the transactions are ranked, financial account provider 110-1 may identify a subset of the transactions based on a predetermined incentive parameter “X” identified, for example, during the configuration process described above in connection with step 210 of FIG. 1 (Step 320). In one embodiment, financial account provider 110-1 may determine that only the top “X” transactions in relation to transaction rank are to be processed by the incentive transaction process. Accordingly, financial account provider 110-1 filters out the remaining transactions by removing them from the data structure storing the ranked transaction information, although other forms of filtering may be employed.

For example, if “X” is set as five, then financial account provider removes transactions T6 and T7 listed in Table 2 from consideration. In alternative embodiments, “X” may be equal to the same number of transactions collected and ranked by financial account provider 110-1. In such instances, financial account provider will consider all of the collected transactions during the incentive transaction process.

Once the ranked transactions are filtered, financial account provider 110-1 may store the ranked transaction information in a memory location for subsequent processing by the transaction incentive process (Step 330).

Referring back to FIG. 2, based on the ranked transactions, financial account provider 110-1 may perform an incentive process that analyzes the ranked transaction information to determine the type of incentives to apply to the primary financial account (Step 270). In one embodiment, financial account provider 110-1 configures the incentive program parameters based on the type of transactions performed by user 135. For example, financial account provider 110-1 may offer different incentives based on whether user 135 only uses the primary financial account to purchase goods and/or services during the monitored transaction period of time (e.g., a previous billing cycle) or if user 135 uses the primary financial account for a portion of the monitored transactions. The incentives may include adjustments to reward points redeemable for goods and/or services from financial account provider 110-1, merchant(s) 150, or any other entity that may offer rewards based on the number of accumulated reward points associated with the primary financial account. Further, the incentives may include adjustments to financial account parameters, such as interest rate, credit limit, penalty fees, membership fees, and any other type of parameters associated with the primary financial account.

Financial account provider 110-1 may leverage one or more stored rules to determine the type of incentive to apply to the primary financial account based on the transactions performed by user 135 during the monitored transaction time period. The rules are configurable by financial account provider 110-1 such that the incentives and conditions for receiving different incentives may change while user 135 is a holder of the primary financial account. For illustration purposes, Table 3 shows a listing of exemplary rules and corresponding incentives that may be applied by financial account provider 110-1 during the incentive process. The listed rules and incentives are not intended to be limiting and any type of rule and/or condition may be configured and applied for determining the type of incentives for user 135.

TABLE 3
Exemplary Rules, 20Conditions

| Rule | Condition | Incentive |
|---|---|---|
| 1 | All transactions from primary account | Apply first incentive to |
| | | primary financial account |
| 2 | Subset of transactions from primary | Apply second incentive to |
| | financial account | primary financial account |
| 3 | No transactions from primary finan- | Apply third incentive to |
| | cial account (all or some of the trans- | primary financial account |
| | actions are from applicable secondary | (if applicable) |
| | financial accounts) | |
| 4 | User meets forecast goal for future | Apply fourth incentive to |
| | forecast period | primary financial account |
| 5 | All transactions from primary finan- | Apply sixth incentive to |
| | cial account over previous predeter- | primary financial account |
| | mined number of monitored trans- | |
| | action time periods | |
| 6 | No transactions from primary finan- | No incentives applied to |
| | cial account over previous predeter- | primary financial account |
| | mined number of monitored trans- | and/or remove primary |
| | action time periods. | financial account from |
| | | incentive program |

As shown in Table 3, financial account provider 110-1 may apply different incentives to the primary financial account based on the rules/conditions associated with the monitored transactions. The first incentive may include incentives that are more attractive than the other incentives offered by financial account provider 110-1. The term “more attractive” refers to conditions that are more beneficial to user 135 in terms of the primary financial account than less attractive incentives. That is, an incentive that is more attractive than another incentive includes rewards that financially benefit user 135 more than the less attractive incentive. For example, a first incentive may include adding $200 to the credit limit of the primary financial account, while the second incentive may include adding $50 to the same credit limit. Alternatively, the second incentive may include adding a certain amount to the credit limit if the subset of transactions includes a total purchase amount above a predetermined threshold number. The second incentive may also include incentives that are less attractive than the first incentive, but more attractive than certain remaining incentives (i.e., the third incentive).

Additionally, financial account provider 110-1 may vary the incentives when the number of transactions included in the subset are associated with the primary financial account. For instance, the second incentive may include incentives that are more attractive than another type of second incentive based on the number of primary financial account transactions included in the subset. Thus, user 135 may receive more attractive incentives for having four of the “X” financial account transactions associated with the primary financial account as opposed to having two primary financial account transactions (i.e., two of the “X” transactions) associated with the primary account.

Further, financial account provider 110-1 may configure incentives associated with the forecast goal provided by user 135 in Step 210 of FIG. 2. For example, if user 135 forecasts a total transaction amount of $1000.00 for a future monitored time period and user 135 meets that goal, financial account provider 110-1 may apply a fourth incentive that supplements or replaces any other incentives that may be, or has been, applied to the primary financial account. The fourth incentive may be more or less attractive than any other incentives implemented by financial account provider 110-1. Also, financial account provider 110-1 may vary the fourth incentive such that user 135 receives more attractive incentives for higher forecast goal transaction amounts. For instance, if user 135 forecasts and meets a $200 future transaction goal, financial account provider 110-1 may apply a first type of fourth incentive to the primary financial account (e.g., add 100, reward points to an accumulating point number for user 135). If, however, user 135 forecasts and meets a $1000 future transaction goal, financial account provider 110-1 may apply a second type of fourth incentive to the primary financial account that is more attractive than the first type of fourth incentive (e.g., add 500 reward points to the accumulating point number for user 135). The types of fourth incentives may vary based on different numbers of forecast goals based on a predetermined algorithm executed by a processor included in financial account provider 110-1. Alternatively, the types of fourth incentives may be based on a predetermined table of incentive amounts corresponding to various forecast amounts.

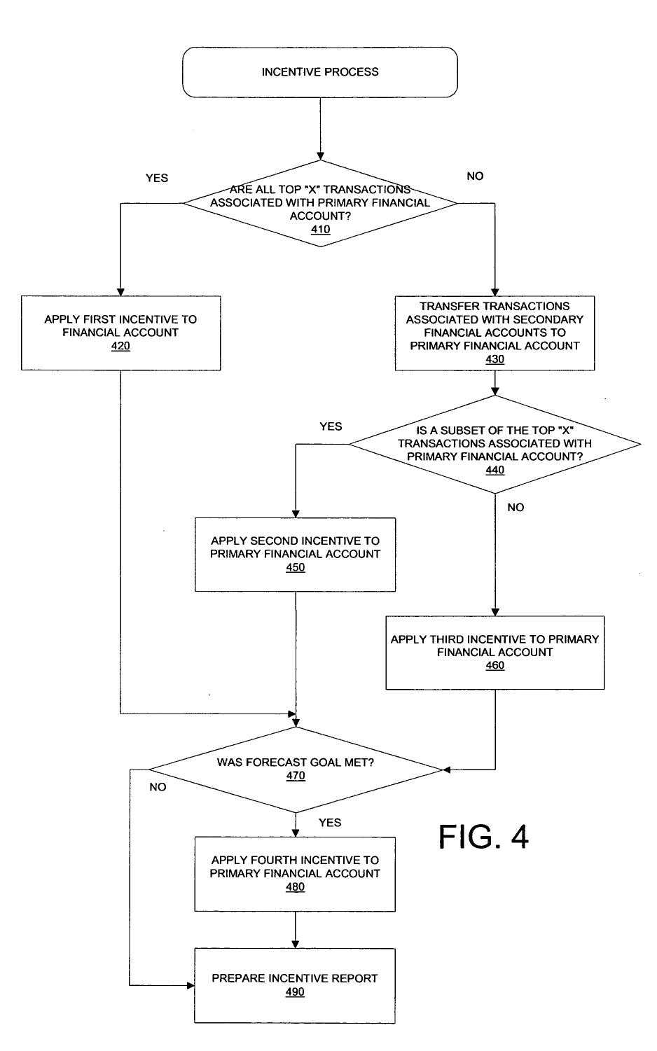

As explained, financial account provider 110-1 may customize incentives for user 135 to provide motivation for using the primary financial account over any secondary financial accounts. FIG. 4 shows a flowchart of an exemplary incentive process consistent with embodiments of the present invention.

Initially, financial account provider 110-1 may determine whether all of the remaining “X” transactions are associated with the primary financial account (Step 410). If so, (Step 410; YES), financial account provider 110-1 may apply a first incentive to the primary financial account based on the parameters and terms configured in Step 210 of FIG. 2 (Step 420). For example, financial account provider 110-1 may leverage rule 1 listed in Table 3 to apply the first incentive to the primary financial account (e.g., increase credit limit, reduce the account's interest rate, reduce or eliminate any penalty or membership fees, add a certain number or reward points, etc.). Once the first incentive is applied, the incentive process may continue to Step 470, which is described in further detail below.

Referring back to Step 410, if financial account provider 110-1 determines that not all of the monitored transactions are associated with the primary financial account (Step 410; NO), it may transfer the transactions associated with any secondary financial accounts to the primary financial account (Step 430). For example (assuming that “x” is equal to five), financial account provider 110-1 may recognize that exemplary transactions T2, T3, and T4 listed in Table 2 are associated with a secondary financial account. Under the terms and conditions associated with the configured primary financial account, financial account provider 110-1 may provide a payment to financial account provider 110-2 for those transactions. For example, financial account provider 110-1 may provide a negotiable instrument paid to the order of an appropriate entity representing financial account provider 110-2 for payment in full of the total balance for transactions T2, T3, and T4. Alternatively, financial account provider 110-1 may provide an electronic payment to financial account provider 110-2 for payment associated with those same transactions.

In addition to making payments to financial account provider 110-2 for transactions T2, T3, and T4, financial account provider 110-1 may apply the total amount of these transactions to the primary financial account. That is, financial account provider 110-1 adds $1250 (i.e., the total transaction amount for T2, T3, and T4) to the balance of the primary financial account.

Once the appropriate secondary transactions are transferred to the primary financial account, financial account provider 110-1 may determine whether a subset of the “X” transactions (e.g., top five transactions from Table 2) are associated with the primary financial account (Step 440). If so, (Step 440; YES), financial account provider 110-1 may apply a second incentive to the primary financial account based on the parameters and terms associated with the incentive program configured in Step 210 of FIG. 2 (Step 450). If, however, none of the top “X” transactions are associated with the primary financial account (Step 440; NO), financial account provider 110-1 may, if applicable, apply a third incentive to the primary financial account (Step 460). That is, financial account provider 110-1 may have configured one or more rules that prevent any incentives to be applied to the primary financial account if user 135 does not use that account for purchase transactions during the monitored transaction period. Alternatively, financial account provider 110-1 may apply less attractive incentives to the primary financial account if user 135 uses one or more types of secondary financial accounts for the transactions. For example, financial account provider 110-1 may set up an agreement with one or more other financial account providers (e.g., provider 110-2) that motivate financial account provider 110-1 to apply a third incentive to the primary financial account when user 135 uses the secondary financial accounts corresponding to the other providers (e.g., financial account provider 110-2).

Although not shown in the incentive process of FIG. 4, financial account provider may apply other incentives to the primary financial account based on other conditions associated with the monitored transactions of user 135. Accordingly, the processes described in connection with Steps 410-460 are not intended to be limiting.

At Step 470, financial account provider 110-1 may determine whether transaction amounts associated with the primary financial account meets or exceeds the forecast goal provided by user 135 during Step 210 of FIG. 2. Following the exemplary transactions listed in Table 2, financial account provider 110-1 may determine that the total transaction amount for the primary financial account is $750. Therefore, if the forecast goal provided by user 135 in Step 210 of FIG. 2 is above $750 (i.e., if the forecast goal is met) (Step 470; YES), financial account provider 110-1 may apply a fourth incentive to the primary financial account (Step 480). As explained, the fourth incentive may or may not be more attractive than one or more of the other incentives applied by financial account provider 110-1.

If the forecast goal was not met (Step 470; NO) or following application of the fourth incentive (Step 480), financial account provider 110-1 may prepare an incentive report (Step 490). The incentive report may include information associated with the monitored transactions and the incentives applied to the primary financial account (if any were applied). Further, the incentive report may include information identifying missed incentives that user 135 may have been able to obtain if certain transaction conditions were met during the monitored transaction time period. For example, the incentive report may include information explaining that if user 135 used the primary financial account to perform transactions T2, T3, and T4 (listed in Table 2), a first incentive would have been applied to the primary financial account instead of the second incentive. Financial account provider 110-1 stores the incentive report in a memory device for subsequent processing.

Referring back to FIG. 2, once the incentive process is complete and the incentive report generated, financial account provider 110-1 may notify user 135 of the incentives or missed incentives using the incentive report information (Step 280). Financial account provider 110-1 may mail an account statement including the incentive report information or may provide the information electronically via network 120. Accordingly, user 135 periodically receives information describing the incentives offered and/or obtained by user 135 using the primary financial account for purchasing goods and/or services. Further, user 135 receives information describing the incentives obtained or could have been obtained by meeting a forecast goal for the previous monitored transaction time period.

In one embodiment, financial account provider 110-1 may also include information in the incentive report describing incentives that the may be obtained if user 135 predicts and meets certain forecast goals for an upcoming monitored transaction period. For example, financial account provider 110-1 may determine, based on any configured rules and/or incentive program parameters, different incentives that may be obtained by meeting certain forecast goals. This information is included in the notification to user 135. Thus, user 135 may have information available for consideration prior to making a forecast goal for an upcoming monitored transaction period.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims. For example, the process steps shown in FIGS. 2-4 are not limited to the sequences described above. Variations of these sequences, such as the removal and/or the addition of other process steps may be implemented without departing from the spirit and scope of the present invention.

Additionally, the present invention may be applied to financial accounts other than credit card accounts. Any financial institution that provides financial accounts to customers may employ methods, systems, and articles of manufacture consistent with certain principles related to the present invention.

Furthermore, although aspects of the present invention are described as being associated with data stored in memory and other storage mediums, one skilled in the art will appreciate that these aspects can also be stored on or read from other types of computer-readable media, such as secondary storage devices, like hard disks, floppy disks, or CD-ROM; a carrier wave from the Internet; or other forms of RAM or ROM. Accordingly, the invention is not limited to the above described embodiments, but instead is defined by the appended claims in light of their full scope of equivalents

1. A method for providing incentives for a first financial account held by a user and associated with a first financial account provider, wherein the user also holds a second financial account associated with a second financial account provider, the method comprising:
monitoring transactions performed using the first and second financial accounts over a predetermined transaction monitoring period;
determining whether the monitored transactions meet at least one predetermined condition; and
applying an incentive to the first financial account based on the predetermined condition.

2. The method of claim 1, wherein monitoring the transactions includes:
collecting, by the first financial account provider, transaction information associated with each of the transactions from at least one of:
the user,
a merchant associated with a transaction with the user,
a server system that collects the transaction information, and
the second financial account provider.

3. The method of claim 1, further including:
configuring the first financial account based on input received from the user.

4. The method of claim 1, further including:
receiving a forecast goal from the user reflecting a estimated transaction amount the user intends to perform using the first financial account over a future transaction monitoring period.

5. The method of claim 4, wherein determining whether the monitored transactions meet at least one predetermined condition includes:
determining whether the transactions includes purchase amounts associated with the first financial account that collectively meet the forecast goal.

6. The method of claim 5, wherein applying the incentive includes:
applying an incentive to the first financial account when the forecast goal is met.

7. The method of claim 1, wherein determining whether the monitored transactions meet at least one predetermined condition includes:
determining whether all of the transactions are associated with the first financial account.

8. The method of claim 7, wherein applying the incentive includes:
applying a first incentive to the first financial account when all of the transactions are associated with the first financial account, wherein the first incentive is more attractive than other incentives that may be applied to the first financial account when the at least one of the transactions are not associated with the first financial account.

9. The method of claim 1, wherein determining whether the monitored transactions meet at least one predetermined condition includes:
determining whether a subset of the transactions are associated with the first financial account.

10. The method of claim 9, wherein the financial account provider is configured to apply a first and second incentive to the first financial account and applying the incentive includes:
applying the second incentive to the first financial account when a subset of the transactions are associated with the first financial account, wherein the second incentive is less attractive than the first incentive that may be applied to the first financial account when all of the transactions are associated with the first financial account.

11. The method of claim 10, wherein the second incentive is more attractive than a third incentive that is applied to the first financial account when the transactions include a fewer number of transactions associated with the first financial account than the number of transactions included in the subset of transactions.

12. The method of claim 1, wherein determining whether the monitored transactions meet at least one predetermined condition includes:
determining whether any of the transactions are associated with the second financial account; and
transferring any second financial account transactions to the first financial account based on the determination.

13. The method of claim 12, wherein transferring any second financial account transactions includes:
providing payment for the second financial account transactions from the first financial account provider to the second financial account provider; and
adding a total transaction amount associated with the second financial account transactions to a balance associated with the first financial account.

14. The method of claim 13, wherein the user gives authorization to the first financial account provider to transfer the second financial account transactions to the first financial account.

15. The method of claim 1, wherein the incentive includes at least one of adjusting an interest rate for the first financial account, adjusting a credit limit for the first financial account, adjusting an account fee associated with the first financial account, and adding reward points to accumulating reward point total associated with the first financial account.

16. The method of claim 1, wherein the incentive is more attractive to the user when more of the transactions are associated with the first financial account as opposed to the second financial account.

17. The method of claim 1, further including:
providing an incentive report to the user based on the applied incentive.

18. The method of claim 17, wherein the incentive report includes information associated with incentives that may have been applied to the first financial account based on different types of the predetermined condition.

19. The method of claim 1, wherein determining whether the monitored transactions meet at least one predetermined condition includes:
ranking the transactions based on a transaction parameter associated with each transaction;
identifying a set of the transactions that each have a transaction parameter that meets or exceeds a predetermined transaction parameter threshold; and
determining whether the set of transactions meet the at least one predetermined condition.

20. The method of claim 19, wherein the at least one predetermined condition includes at least one of:
whether all of the transactions in the set of transactions are associated with the first financial account;
whether a portion of the transactions in the set of transactions are associated with the second financial account;
whether none of the transactions in the set of transactions are associated with the first financial account; and
whether any transactions in the set of transactions are associated with the first financial account and an aggregated value of transaction parameters associated with the first financial account transactions in the set meets a user defined forecast goal.

21. A system for providing incentives for a first financial account, comprising:
a first financial account provider managing the first financial account;
a second financial account provider managing a second financial account; and
a user associated with the first and second financial accounts,
wherein the first financial account provider is configured to:
monitor purchase transactions performed by the user over a transaction time period,
determine whether the purchase transactions meet at least one predetermined condition, and
apply an incentive to the first financial account based on the predetermined condition.

22. The system of claim 21, wherein the first financial account provider is configured to monitor the purchase transactions by:
collecting, by the first financial account provider, transaction information associated with each of the purchase transactions from at least one of:
the user,
a merchant associated with a transaction with the user,
a server system that collects the transaction information, and
the second financial account provider.

23. The system of claim 21, wherein the first financial account provider is further configured to receive a forecast goal from the user reflecting a estimated transaction amount the user intends to perform using the first financial account over a future transaction monitoring period.

24. The system of claim 21, wherein the first financial account provider is configured to determine whether the monitored transactions meet the at least one predetermined condition by determining whether the purchase transactions includes transaction amounts associated with the first financial account that collectively meet the forecast goal.

25. The system of claim 24, wherein the first financial account provider is configured to apply the incentive to the first financial account when the forecast goal is met.

26. The system of claim 21, wherein the first financial account provider is configured to determine whether the monitored transactions meet the at least one predetermined condition by determining whether all of the transactions are associated with the first financial account.

27. The system of claim 26, wherein the first financial account provider is configured to apply a first incentive to the first financial account when all of the transactions are associated with the first financial account, wherein the first incentive is more attractive than other incentives that may be applied to the first financial account when the at least one of the transactions are not associated with the first financial account.

28. The system of claim 21, wherein the first financial account provider is configured to determine whether the monitored transactions meet the at least one predetermined condition by determining whether a subset of the transactions are associated with the first financial account.

29. The system of claim 28, wherein the incentive maybe a first or second incentive and the financial account provider is configured to apply the second incentive to the first financial account when only a subset of the transactions are associated with the first financial account, wherein the second incentive is less attractive than the first incentive that may be applied to the first financial account when all of the transactions are associated with the first financial account.

30. The system of claim 29, wherein the second incentive is more attractive than a third incentive that is applied to the first financial account when the transactions include a fewer number of transactions associated with the first financial account than the number of transactions included in the subset of transactions.

31. The system of claim 21, wherein the first financial account provider is configured to determine whether the monitored transactions meet the at least one predetermined condition by determining whether any of the transactions are associated with the second financial account and transferring any second financial account transactions to the first financial account based on the determination.

32. The system of claim 31, wherein the first financial account provider transfers any second financial account transactions by providing payment for the second financial account transactions from the first financial account provider to the second financial account provider and adding a total transaction amount associated with the second financial account transactions to a balance associated with the first financial account.

33. The system of claim 32, wherein the user gives authorization to the first financial account provider to transfer the second financial account transactions to the first financial account.

34. The system of claim 21, wherein the incentive includes at least one of adjusting an interest rate for the first financial account, adjusting a credit limit for the first financial account, adjusting an account fee associated with the first financial account, and adding reward points to accumulating reward point total associated with the first financial account.

35. The system of claim 21, wherein the incentive is more attractive to the user when more of the transactions are associated with the first financial account as opposed to the second financial account.

36. The system of claim 21, wherein the first financial account provider is further configured to provide an incentive report to the user based on the applied incentive.

37. The system of claim 36, wherein the incentive report includes information associated with incentives that may have been applied to the first financial account based on different types of the predetermined condition.

38. A computer-readable medium including instructions for performing a method, when executed by a processor, for providing incentives for a first financial account held by a user and associated with a first financial account provider, wherein the user also holds a second financial account associated with a second financial account provider, the method comprising:
monitoring transactions performed using the first and second financial accounts over a predetermined transaction monitoring period;
determining whether the monitored transactions meet at least one predetermined condition; and
applying an incentive to the first financial account based on the predetermined condition.

39. A method for providing incentives for a first financial account held by a user and associated with a first financial account provider, wherein the user also holds a second financial account associated with a second financial account provider, the method comprising:
monitoring transactions performed using the first and second financial accounts over a predetermined transaction monitoring period;
determining whether the monitored transactions include at least one transaction associated with the second financial account; and
transferring the at least one second financial account transaction to the first financial account such that the first financial account provider sends a payment to the second financial account provider for the at least one second financial account transaction and applying a total purchase amount for the at least one second financial account transactions to a balance of the first financial account.
